(19) United States
(12) Patent Application Publication
(10) Pub. No.: US 2007/0234278 A1
(43) Pub. Date: Oct. 4, 2007

(54) Managing source code in a model-based development environment

(75) Inventors: Christian Heide Damm, Hillerod (DK); Michael Svanholm Thomsen, Copenhagen (DK); Ronald K. Gabel, Copenhagen (DK)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/366,244

(22) Filed: Mar. 2, 2006

(51) Int. Cl. G06F 9/44

(52) U.S. Cl. 717/104

(57) ABSTRACT

A model-based application development system includes a model element. Also included is source code that corresponds to the model element. One or more computer-implemented system management components are then collectively configured to modify the source code to reflect a developer-initiated manipulation of the model element.

### BACKGROUND

It is common for an application development environment to involve having a developer work with model elements defined in a database. For at least some of the model elements, there is related source code defined in one or more source code files. In many cases, model elements and corresponding source code files are weakly coupled to each other. For example, a naming convention may be employed wherein the name of a source code file is related to the name of a corresponding model element.

Given an environment such as that described, one problem that arises is that, when a model element is renamed for which there is a related source code file, the user must manually rename the source code file to maintain the weak coupling. In general, it is often desirable for source code to follow model elements as a developer makes changes to the model. Typically, the developer must manually ensure this.

There are many applicable example scenarios. For instance, when a developer creates a model element, then the developer often must create a corresponding source code file with a corresponding name. Similarly, when a developer renames a model element, the developer often must manually rename related source code files. When a developer deletes a model element, the developer will often desire to delete corresponding source code because it is no longer needed. When a developer actuates an “undo” function after deleting a model element, the developer may be forced to somehow retrieve the corresponding source code (e.g., through the Source Code Control API, from the Recycle Bin, etc.). When a developer actuates a “copy” command when a given model element is selected, and when the developer subsequently actuates a “paste” command in the same or another model file, then the developer often must make a copy of the corresponding source code and include it in an additional appropriate context. The situation is similar for “cut” and “paste” commands. In a final example, when a developer deletes an entire model file, the developer often manually deletes source code files for corresponding model elements.

The discussion above is merely provided for general background information and is not intended for use as an aid in determining the scope of the claimed subject matter. Further, it should also be emphasized that the claimed subject matter is not limited to implementations that solve any or all of the disadvantages of any currently known systems noted in this section.

### SUMMARY

A model-based application development system includes a model element. Also included is source code that corresponds to the model element. One or more computer-implemented system management components are then collectively configured to modify the source code to reflect a developer-initiated manipulation of the model element.

This Summary is provided to introduce, in a simplified form, a selection of concepts that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one computing environment in which some embodiments may be practiced.

FIG. 2 is a schematic diagram of an application development system.

FIGS. 3-9 are block flow diagrams demonstrating methods that can be employed to update source code to reflect changes to corresponding model elements.

### DETAILED DESCRIPTION

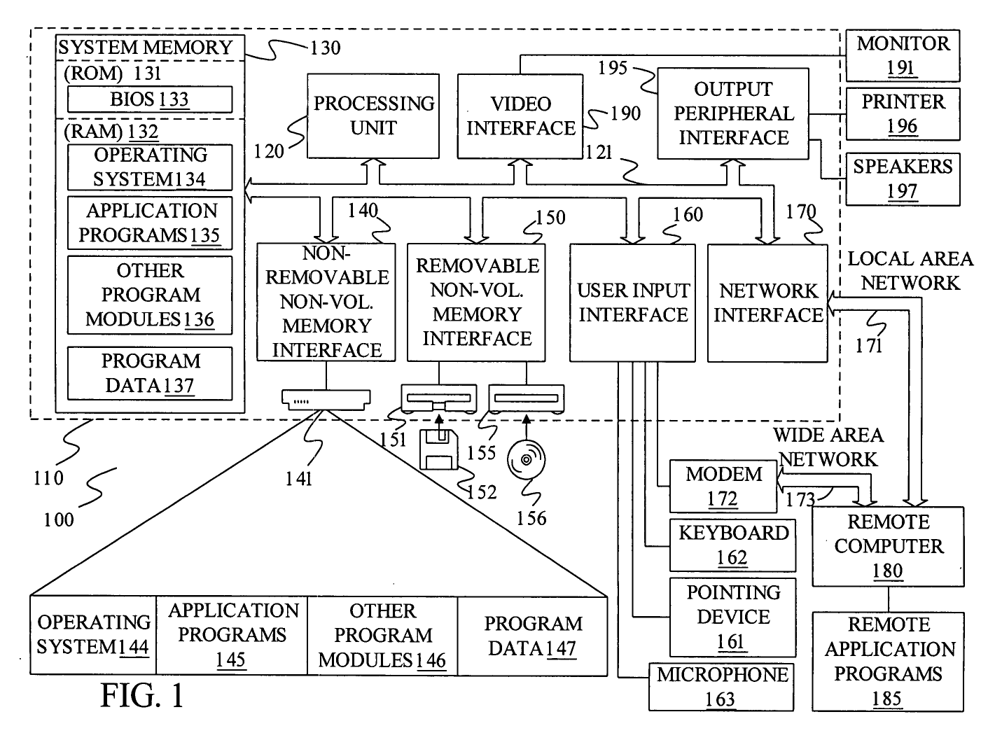

FIG. 1 illustrates an example of a suitable computing system environment 100 in which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

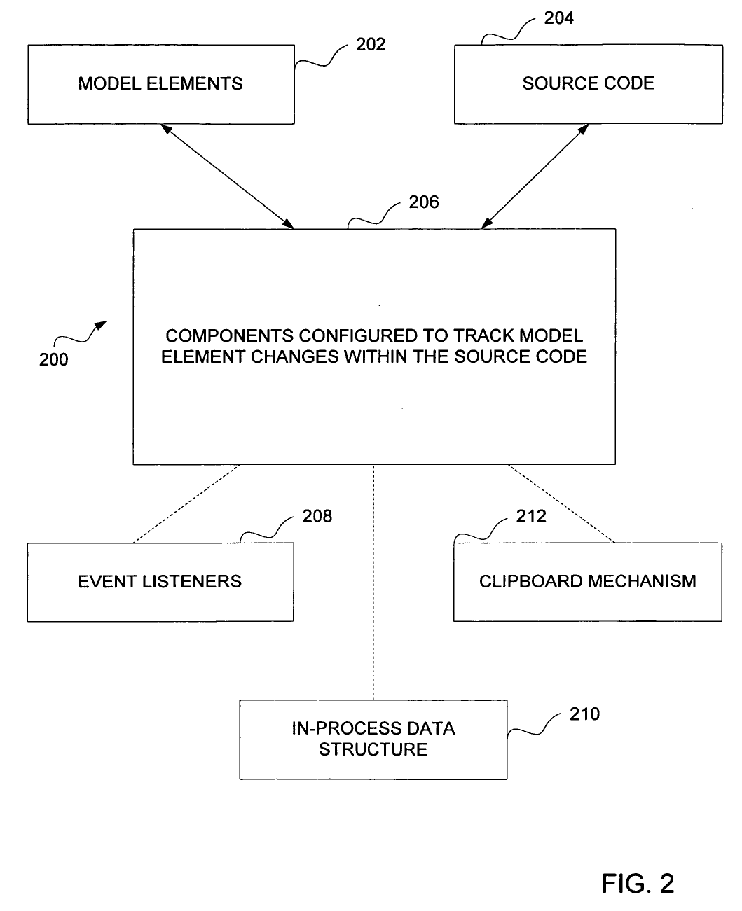

FIG. 2 is a schematic diagram of an application development system 200. System 200 includes one or more model elements 202, which, not by limitation, may be collectively defined within a database, such as within an XML-file. Also included in the system is source code 204. Source code 204 illustratively includes one or more source code files (e.g., C#/Visual Basic, etc.). One or more source code files illustratively correspond to one or more model elements. It should be emphasized that it is within the scope of the present invention for multiple source code files to be linked to a single model element (or a single source code file to be linked to multiple model elements). Assumedly, it is desirable to maintain source code files 204 so as to be an accurate reflection of corresponding model elements. Further, it is assumed that it is desirable to perform such maintenance without required significant manual intervention by the developer.

System 200 further comprises a collection of components 206 that are configured to track changes to model elements 202 within source code 204. More specifically, components 206 are configured to ensure that whatever action the user does relative to model elements 202 is accounted for in related source code files. Components 206 are illustratively configured to adjust source code 204 as necessary to maintain proper name, lifetime and location relative to changes made to model elements 202. In one embodiment, adjustments to source code 204 are made automatically and transparently. In one embodiment, adjustments to source code 204 are made without requiring the developer to access or retrieve the source code. In one embodiment, adjustments are made to source code 204 without requiring the developer to do anything to make the adjustments occur. In another embodiment, one or more adjustments are effectuated only following confirmation or approval by the developer.

Components 206 illustratively incorporate a variety of specific mechanisms configured to support the accounting of model element changes within the source code. An example of such a mechanism is event listeners 208. Event listeners 208 are illustratively configured to monitor one or more model elements 202 for events indicative of adding, renaming or removing model elements. Upon detection of such an event, a mechanism is employed to take care of creating, renaming or deleting corresponding source code files. In accordance with one embodiment, event listeners receive events from in-memory representations (e.g., representations of model elements) and not from a file system. Those skilled in the art will appreciate that this isn't necessarily the case. This issue is raised simply to emphasize that it is not critical to the present invention that implementation be restricted to the physical file, an in-memory representation, or the like.

Another example of a mechanism included in components 206 is an in-process data structure 210. When model elements are removed or cut, in-line process data structure 210 is configured to support an undo or re-do function. Specifically, if the model elements come back, then so do the source code files in the same state and with the same contents as before they were removed or cut.

In order to support a cutting or copying of model elements, the associated source code files are stored, for example but certainly not by limitation, on a clipboard mechanism 212. When pasting model elements, the clipboard is queried to re-create relevant source code files. The re-created files may then be coupled to pasted model elements (which may be duplicates in the scenario where the user copies and pastes).

It should be noted that mechanisms 208, 210 and 212 are simply examples of mechanisms that can be employed to ensure that source code 204 follows and reflects changes made to model elements 202. Those skilled in the art will appreciate that different, additional or fewer mechanisms can be employed without departing from the scope of the present invention. It is the general function of tracking changes that is most important to the spirit of the present invention.

The present description will now transition to describing examples of methods that component 206 can be configured to perform. As will become apparent, the example methods will be described as a series of actions and corresponding responses. In general, the “actions” represent manipulations to model data. The “responses” represent steps taken to manipulate source code to reflect corresponding “actions.”

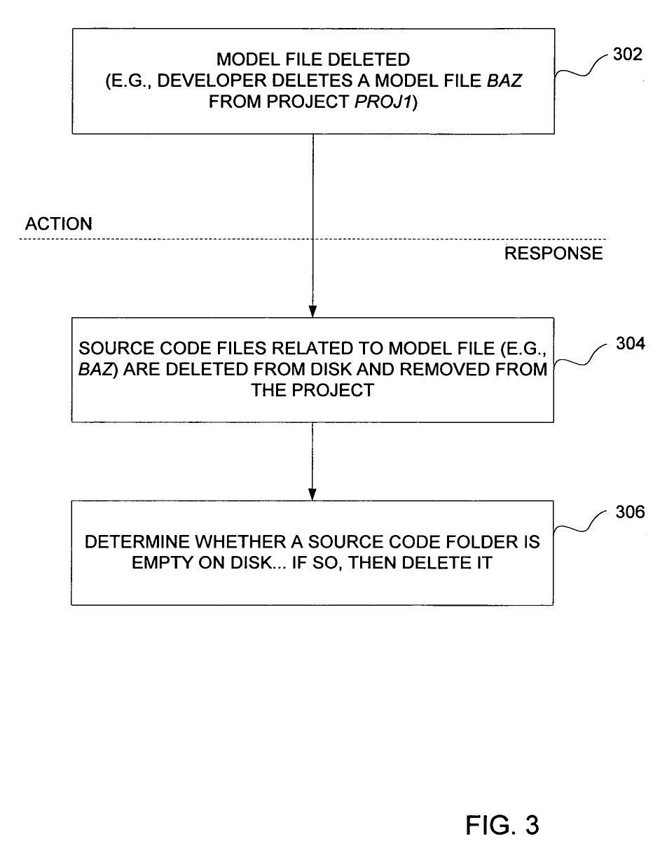

FIG. 3 is a block flow diagram of a first method. In accordance with block 302, the action block in this case, a developer deletes a model file. In response, as is indicated by block 304, all files related to the deleted model file are deleted and removed from the corresponding project. In an optional step, as is indicated by block 306, a determination is made as to whether the deleting of source code files produces one or more empty folders. If so, empty folders are deleted.

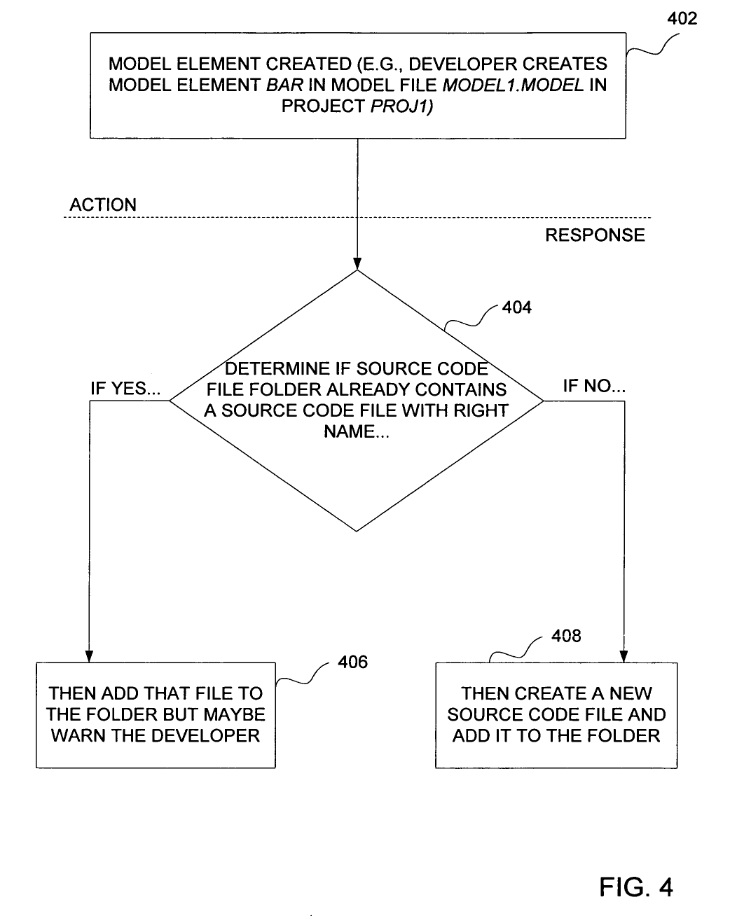

FIG. 4 is a block flow diagram of another method. In accordance with block 402, the action block, a developer creates a model element. In response, as is indicated by block 404, a determination is made as to whether the source code already contains a source code file that corresponds to the new model element. As is indicated by block 406, if the determination is positive, then the pre-existing file is relied upon again. In this case, the developer may be warned with a message such as “An existing source code file with matching name ‘<name>’ was unexpectedly found in the source code file folder. It has been added to project ‘<project name>’”. As is indicated by block 408, if no file exists, then a new source code file is created in the folder and added to the project.

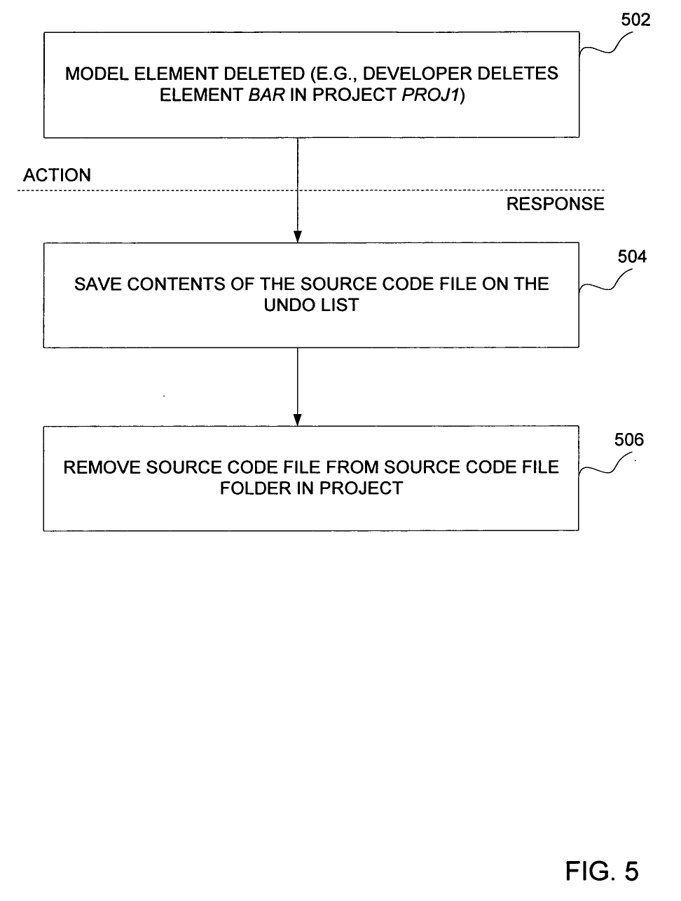

FIG. 5 is a block flow diagram of another method. In accordance with block 502, the action block, the developer deletes a model element. In response, as is indicated by block 504, the corresponding source code file contents are saved on an undo list. In accordance with block 506, the source code file is then removed from the source code file in the corresponding project.

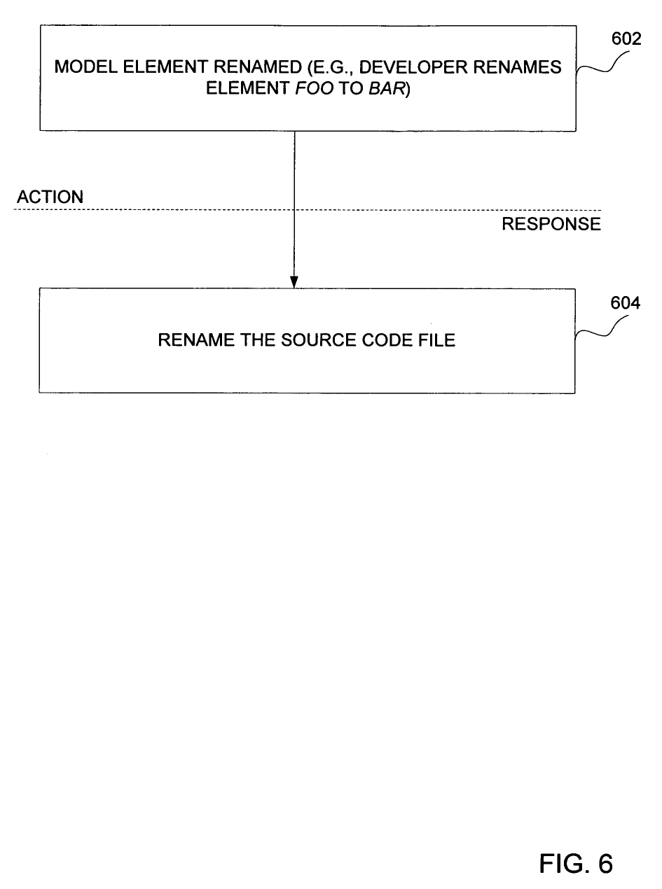

FIG. 6 is a block flow diagram of another method. In accordance with block 602, the action block, the developer renames a model element. In response, as is indicated by block 602, the corresponding source code file is renamed.

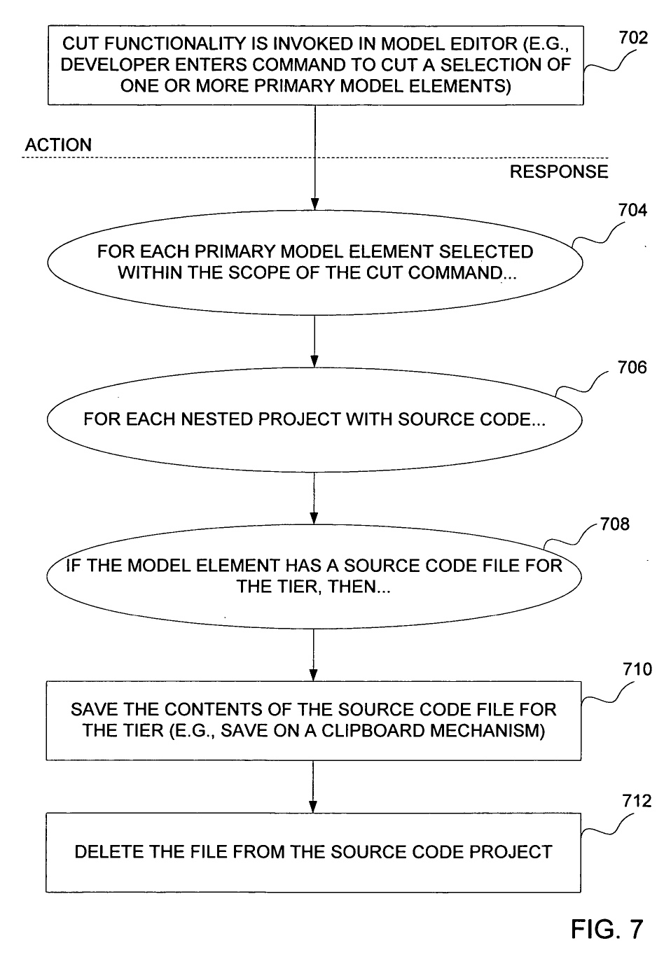

FIG. 7 is a block flow diagram of another method. In accordance with block 702, the action block, the developer asserts a cut command relative to one or more model elements. In accordance with the example method, qualifiers 704, 706 and 708 are applied to ensure a systematic and complete response. In particular, the response of block 710 and 712 is applied 1) for each primary model element selected within the scope of the cut command; 2) for each nested project with source code; and 3) such that application assumes a model element with a source code file for the relevant tier. It should be noted that items 2 and 3 apply to each instance of item 1. The actual response comprises saving contents of the source code file for the tier (block 710) and then deleting the file from the source code project (block 712).

It should be noted that the systematic application of a rule as reflected in any or all of preliminary qualifying steps 704, 706, 708 is provided as an example. This type of rule application could just as easily be applied to any other scenario including any scenario described in FIGS. 3-9. For example, if a group of elements is deleted, corresponding action can illustratively be taken in the source code “for each model element,” “for each nested project,” etc. It should also be noted that other systematic approaches could be employed without departing from the scope of the present invention. Also, a specific systematic approach is not a necessity. For example, any method, even a simple method, for affecting corresponding source code file(s) is within the scope of the present invention. It isn't critical to the present invention that rules be applied to source code on a tier-by-tier or project-by-project basis. It isn't critical to the present invention that source code be organized in tiers or projects. Source code may live in project(s) distinct from the project(s) that contain the model files.

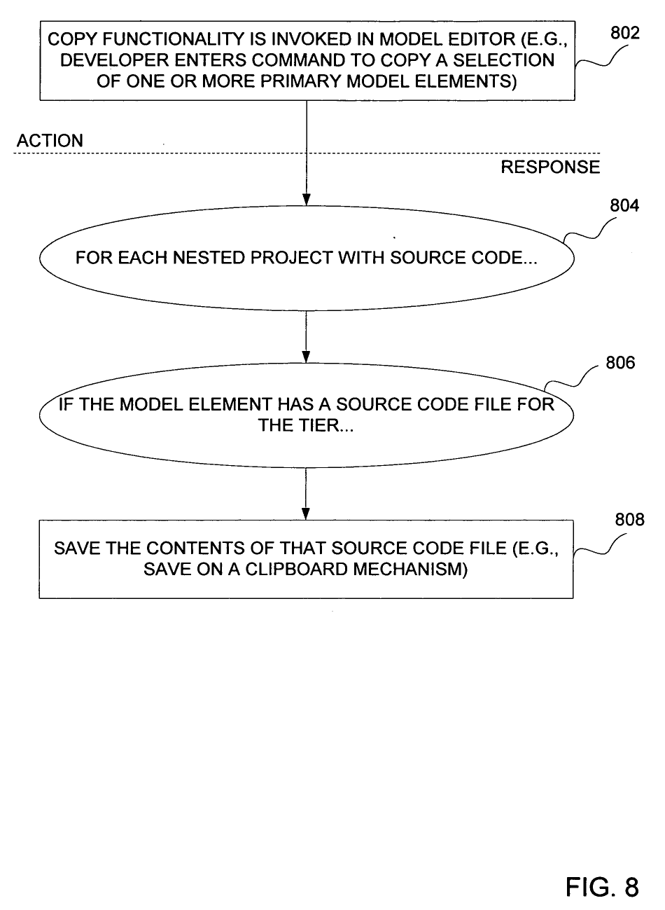

FIG. 8 is a block flow diagram of another method. In accordance with block 802, the action block, the developer asserts a copy command relative to one or more model elements. In accordance with the example method, qualifiers 804 and 808 are applied to ensure a systematic and complete response. In particular, the response of block 808 is applied 1) for each nested project with source code (oval 804); and 2) such that application assumes a model element with a source code file for the relevant tier (oval 806). The actual response comprises saving contents of the source code file (block 808).

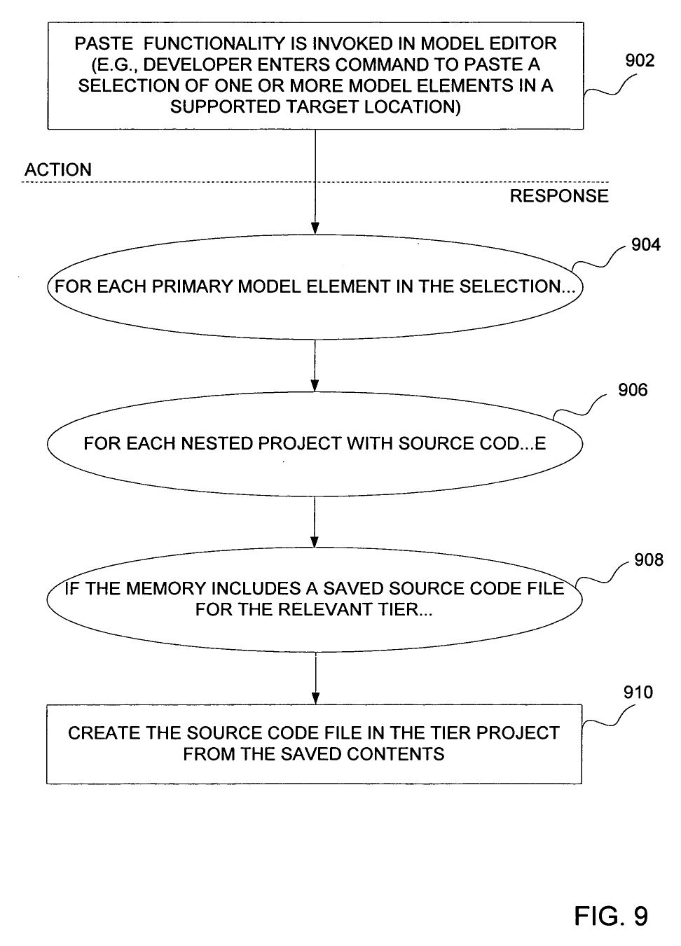

FIG. 9 is a block flow diagram of another method. In accordance with block 902, the action block, the developer asserts a paste command relative to one or more model elements. In accordance with the example method, qualifiers 904, 906 and 908 are applied to ensure a systematic and complete response. In particular, the response of block 910 is applied 1) for each primary model element selected within the scope of the paste command; 2) for each nested project with source code; and 3) such that application assumes the memory (e.g., the clipboard mechanism) has a saved source code file for the relevant tier. It should be noted that items 2 and 3 apply to each instance of item 1. The actual response comprises creating the source code in the tier project based on the saved contents (block 910).

Those skilled in the art will appreciate that an ability to “drag‘n’drop” model elements can be implemented in a same or similar manner as the copy/paste functionality herein described. Similarly, an ability to “drag‘n’drop” with shift can be implemented in a same or similar manner as the cut/paste functionality herein described.

Thus, source code modification components can be implemented to at least semi-automatically account for adjustments to model elements. It should be noted that the specific methods described herein are only examples of how such functionality can be implemented. Other similar functions and methods are to be considered within the scope of the present invention.

In one embodiment, a project/model file may contain multiple model elements. That being the case, it makes sense that it is within the scope of the present invention to implement system management components that are collectively configured to modify source code (e.g., one or more source code files) to reflect a developer-initiated manipulation of one or more model elements. In other words, modification of source code could be contingent upon manipulation of one particular model element, any of a plurality of model elements, all of a plurality of model elements, a particular model file, etc.

It is also to be understood that, for a given model element, zero or more source code files may exist. Assuming that only one source file exists for a given model element, that source file will illustratively contain information from the model element but also from related model elements. This type of distinction can be referred to as “primary” versus “secondary” model elements. In one embodiment, the primary element determines the lifetime of the source file, but the name and location could be determined also by the secondary elements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A model-based application development system, comprising:
at least one model element;
source code that corresponds to the model element;
one or more computer-implemented system management components that are collectively configured to modify the source code to reflect a developer-initiated manipulation of the model element.

2. The system of claim 1, wherein the system management components are configured to modify a lifetime characteristic of a source code file to reflect a developer-initiated manipulation of at least one model element.

3. The system of claim 1, wherein the system management components are configured to modify a lifetime characteristic of a source code file to reflect a developer-initiated manipulation of at least one model element.

4. The system of claim 1, wherein the system management components are configured to modify the source code to reflect a deletion of a model file.

5. The system of claim 1, wherein the system management components are configured to modify the source code to reflect a creation of a model element.

6. The system of claim 1, wherein the system management components are configured to modify the source code to reflect a deletion of a model element.

7. The system of claim 1, wherein the system management components are configured to modify the source code to reflect a renaming of a model element.

8. The system of claim 1, wherein the system management components are configured to modify the source code to reflect an invocation of cut functionality in the context of one or more model elements.

9. The system of claim 1, wherein the system management components are configured to modify the source code to reflect an invocation of copy functionality in the context of one or more model elements.

10. The system of claim 1, wherein the system management components are configured to modify the source code to reflect an invocation of paste functionality in the context of one or more model elements.

11. The system of claim 1, wherein the system management components are configured to modify the source code to reflect an invocation of click and drag functionality in the context of one or more model elements.

12. The system of claim 1, wherein the system management components are configured to modify the source code to reflect an invocation of drag and drop functionality in the context of one or more model elements.

13. The system of claim 1, wherein the system management components are configured to modify the source code to reflect an invocation of undo functionality in the context of a change made to one or more model elements.

14. The system of claim 1, wherein the system management components are further configured to automatically modify a plurality of source code files.

15. The system of claim 1, wherein the system management components are further configured to modify the source code without requiring any active participation on the part of the developer.

16. The system of claim 1, wherein the system management components are further configured to modify multiple source code files to reflect a developer-initiated manipulation of a single model element.

17. A computer implemented method for managing source code in a model-based development environment, the method comprising:
receiving an indication that a lifetime characteristic of at least one model element has been altered; and
responding to the indication by making adjustments to corresponding source code.

18. The method of claim 17, wherein making adjustments comprises making adjustments to multiple source code files based on an indication that a lifetime characteristic of a single model element has been altered.

19. A computer implemented method for managing source code in a model-based development environment, the method comprising:
receiving an indication that a location characteristic of at least one model element has been altered; and
responding to the indication by making adjustments to corresponding source code.

20. The method of claim 19, wherein making adjustments comprises making adjustments to multiple source code files based on an indication that a lifetime characteristic of a single model element has been altered.
